(19) United States
(12) Patent Application Publication
(10) Pub. No.: US 2007/0169396 A1
(43) Pub. Date: Jul. 26, 2007

(54) Fishing rod holder with immobilized web

(76) Inventors: John O'Neill, Lenexa, KS (US); Steve Pope, Lenexa, KS (US)

Correspondence Address: HOVEY WILLIAMS LLP, 2405 GRAND BLVD., SUITE 400, KANSAS CITY, MO, 64108, US

(21) Appl. No.: 11/339,289

(22) Filed: Jan. 25, 2006

(51) Int. Cl. A01K 97/10

(52) U.S. Cl. 43/21.2

(57) ABSTRACT

A fishing rod holder (10) is disclosed having a spool assembly (16), a web (18), and a handle assembly (20). The web may be substantially prevented from moving when holding fishing rods in place by a web locking means (46). The web locking means may prevent the spool from turning or a web pinch may be employed, among other embodiments.

### BACKGROUND OF THE INVENTION

1. Field of the Invention

The present invention is broadly concerned with an improved fishing rod holder for securing fishing rods to the walls of vehicles, boats, or other conveyances. More particularly, the invention is concerned with such fishing rod holders having a web for securing the rods to the walls of the conveyance and a means for immobilizing the web to prevent the fishing rods from bouncing or otherwise moving while the conveyance is in motion.

2. Description of the Prior Art

Fishing rod holders are commonly used to hold fishing rods on vehicles, trailers, and boats, such as bass fishing boats and others, to securely stow the fishing rods when the occupants are not fishing. There are many varieties of such holders including those disclosed in U.S. Pat. No. 4,640,039 and U.S. Pat. No. 5,625,973.

The fishing rod holder of U.S. Pat. No. 5,625,973 discloses a holder comprising a spring activated retractable web wrapped around a spool. A handle is connected to the web's end. The spool is mounted within the wall of a boat and the web passes through the wall and may be extended by gripping and pulling on the handle. The fishing rods are placed beneath the extended web and the handle is lockable to the wall. The spool is free to rotate at all times, but is urged to rotate in the direction of retraction by its spring, thereby retracting the web until the web holds the fishing rods against the boat wall. The web is conveniently stowed in the boat wall when fully retracted. One problem encountered by this prior art rod holder is that as the boat proceeds across a body of water and hits waves, the vibration from the interaction between the boat and the waves causes the fishing rods to bounce beneath the web. The spring that retracts the web is not strong enough to hold the web tightly and prevent the rods from bouncing. This can result in damaging the fishing rods and creating a distraction for boat occupants.

The fishing rod holder of U.S. Pat. No. 4,640,039 relies on a strap that is attached to the deck of a boat and has overlapping ends. Fishing rods are placed on top of the strap and then the ends are folded over the fishing rods and held tightly in place by velcro fasteners. This arrangement, does not suffer from the disadvantage of the fishing rods bouncing due to vibrations while the boat is moving. However, the fishing rod holder is permanently fixed to the boat deck, always present on the deck of the boat, and can be in the way when the holder is not being used to hold fishing rods.

Accordingly, it is desirable to provide a fishing rod holder that is automatically stowed out of the way when not in use, but which firmly holds the fishing rods in place while the conveyance is moving.

### SUMMARY OF THE INVENTION

The present teachings solve the problems outlined above and provide a fishing rod apparatus that may be safely stowed within the wall of the conveyance to which it is mounted while not in use and which firmly holds the fishing rods substantially immobilized while the conveyance is in motion.

In one embodiment, the present invention generally provides a fishing rod holder with a retractable web for holding fishing rods to the wall of a conveyance including a means for substantially immobilizing the web when it has been extended and is holding fishing rods in place.

In another embodiment, a retractable web is attached to a spool assembly comprising a ratchet wheel, a ratchet handle, and a locking bar that substantially immobilizes the web when it has been extended and is holding fishing rods in place.

In another embodiment, a retractable web is attached to a spool assembly comprising a spring, a ratchet handle, and a web lock that substantially immobilizes the web when it has been extended and is holding fishing rods in place.

It is understood that both the foregoing general description and the following description of various embodiments are exemplary and explanatory only and are not restrictive of the invention as claimed. The accompanying drawings, which are incorporated in and constitute a part of this specification, illustrate some embodiments, and together with the description serve to explain the principles of the embodiments described herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a perspective view of two fishing rod holders of one embodiment of the present invention installed on a boat;

FIG. 2 is a bottom front perspective view of one embodiment of a fishing rod holder of the present invention in an extended position;

FIG. 3 is a bottom rear perspective view of one embodiment of a fishing rod holder of the present invention;

FIG. 4 is an exploded view of one embodiment of a reel and panel assembly of a fishing rod holder of the present invention;

FIG. 5 is a front view of one embodiment of a fishing rod holder of the present invention;

FIG. 6 is a top view of one embodiment of a fishing rod holder of the present invention mounted on a wall;

FIG. 7 is a top view of one embodiment of a handle assembly of a fishing rod holder of the present invention;

FIG. 8 is a side view of one embodiment of a fishing rod holder of the present invention taken at line 8 from FIG. 5;

FIG. 9 is a cross sectional side view of one embodiment of a fishing rod holder of the present invention taken at line 9 from FIG. 5;

FIG. 10 is a cross sectional side view of one embodiment of a fishing rod holder of the present invention;

FIG. 11 is cross sectional side view of one embodiment of a fishing rod holder of the present invention;

FIG. 12 is cross sectional side view of one embodiment of a fishing rod holder of the present invention;

FIG. 13 is a cross sectional view of the handle assembly taken at line 13 from FIG. 7;

FIG. 14 is cross sectional view of the handle and assembly taken at line 14 from FIG. 7.

FIG. 15 is a front perspective view of one embodiment of a fishing rod holder of the present invention;

FIG. 16 is an exploded view of one embodiment of a fishing rod holder of the present invention;

FIG. 17 is a front view of one embodiment of a fishing rod holder of the present invention;

FIG. 18 is a side cross sectional view of the fishing rod holder of FIG. 17 taken at line 18 and mounted to a wall;

FIG. 19 is a side cross sectional view of the fishing rod holder of FIG. 17 taken at line 19; and

FIG. 20 is a cross sectional side view of the fishing rod holder of FIG. 17 taken at line 19.

### DETAILED DESCRIPTION OF THE PREFERRED EMBODIMENT

Reference will now be made in detail to some embodiments, examples of which are illustrated in the accompanying drawings. Where ever possible, the same reference numbers are used throughout the drawings to refer to the same or like parts.

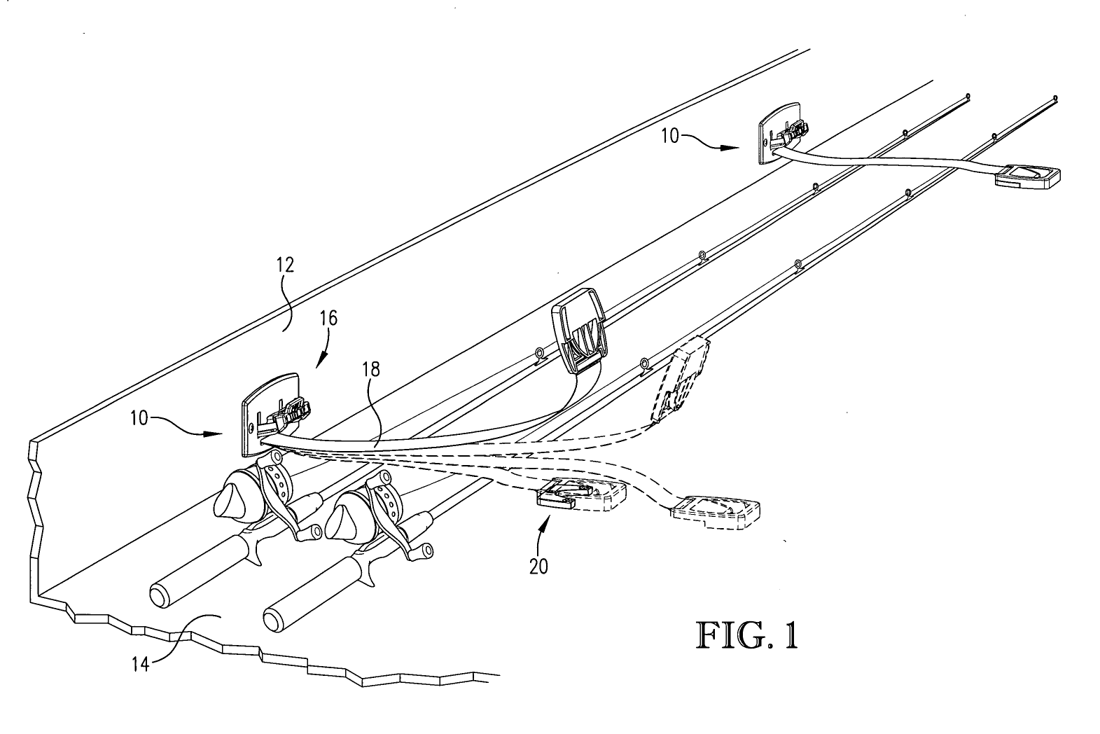

Turning now to the drawings, FIG. 1 shows a front perspective view of one embodiment of two fishing rod holders 10 of the present invention. In FIG. 1, the fishing rod holders 10 are mounted to the side wall 12 of a boat. While depicted here mounted to a boat, the holders are not limited to boat applications, but may be used with any mode of transport including motor vehicles, trailers, and other conveyances as will be appreciated by those skilled in the art. The boat also has a bottom wall or deck 14 and two fishing rods are depicted laying on the bottom wall 14 to be secured by the fishing rod holders 10. The operation of the fishing rod holders is further discussed below.

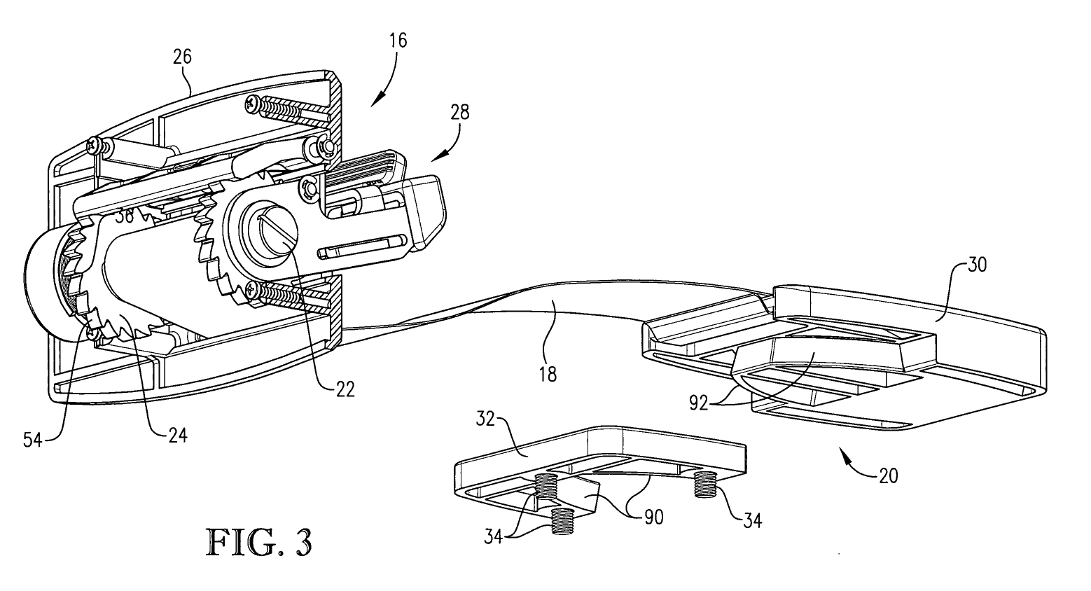

As seen in FIG. 3, in one embodiment, the fishing rod holder includes a spool assembly 16, a web 18, and a web handle assembly 20. The spool assembly includes a spool 22 having ratchet wheels 24 with teeth 54, a front panel 26 on which the spool is rotatably mounted, and a ratchet handle sub-assembly 28 for actuating the ratchet. The web handle assembly 20 includes both a handle 30 and a handle stop 32. The handle 30 is attached to one end of the web 18 and is used for manually extending the web 18. The handle stop 32 includes three openings for passing screws 34 that will be used to mount the handle stop 32 to a wall when the rod holder is attached to a conveyance.

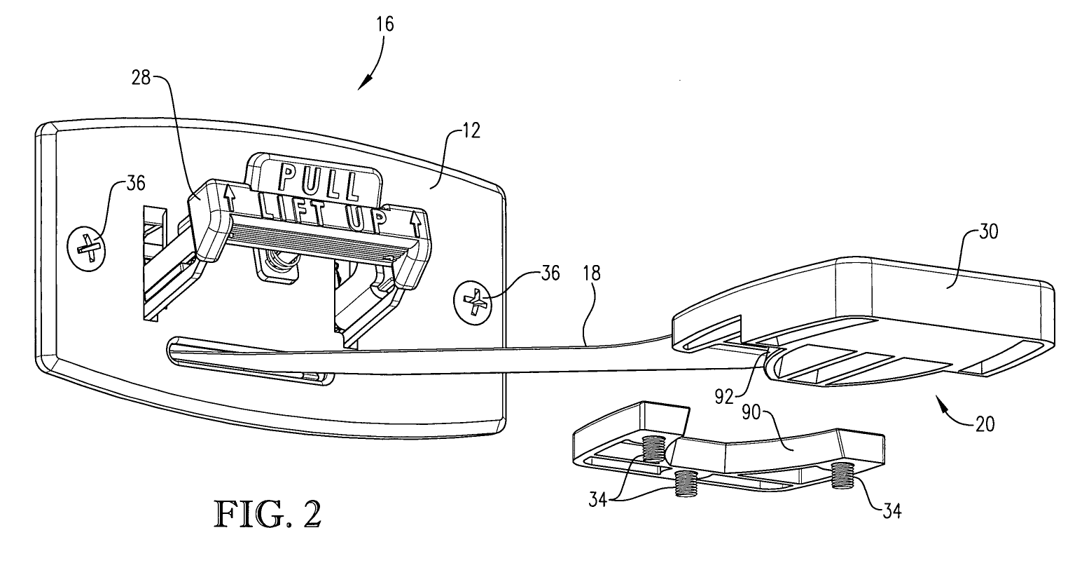

FIG. 2 shows a front perspective view of a single fishing rod holder of the present invention. The ratchet handle sub-assembly 28, web 18, and web handle assembly 20 can be seen. Also depicted are two screws 36 that are passed through front panel 26 and used for mounting the spool assembly 16 to the wall of a conveyance.

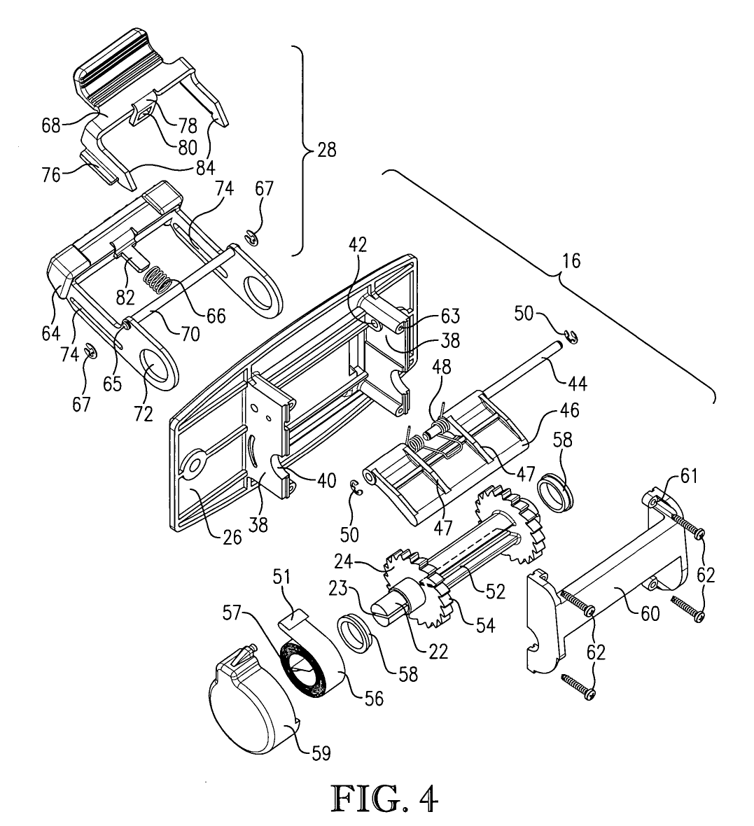

FIG. 4 shows an exploded view of the spool assembly 16 of one embodiment of the present invention. The spool assembly includes a front panel 26. The front panel includes two upright walls 38, each having a spool receiving recess 40 for rotatably mounting spool 22. Walls 38 also each contain an opening 42 for receiving a locking bar rod 44. Mounted to the locking bar rod 44 is a locking bar 46 and a locking bar torsion spring 48. When it is assembled, the locking bar rod 44 is held in place relative to the upright walls 38 by two end pieces 50. The locking bar 46 has two cross members 47 that engage with the ratchet handle as further described below. Spool 22 has an opening 52 for attaching web 18. The spool also has two ratchet wheels 24 with teeth 54 and is attached to a flat torsion spring 56 that urges spool rotation to retract web 18 onto the spool. Spool 22 is mounted in the upright wall recesses 40, rear attachment 60 is mounted over spool 22 and is attached to upright walls 38 by passing screws 62 through rear attachment openings 61 and into upright wall openings 63. Each end of spool 22 is held in place by a bushing 58. Flat torsion spring 56 is attached to spool 22 by inserting spring lead 57 into opening 23 of the spool. Torsion spring housing 59 is then mounted over the spring onto one of the upright walls.

Mounting through the front of the spool assembly is ratchet handle sub-assembly 28, comprising a ratchet handle 64 that includes a release handle bias spring 66, a release handle 68, and a ratchet handle rod 70. Ratchet handle rod 70 mounts to ratchet handle 64 through openings 65 and is secured by end pieces 67. Ratchet handle 64 has two openings 72 for mounting on spool 22. Release handle 68 is slideably mounted to ratchet handle 64 through elongated openings 74 by inserting protrusions 76 on the release handle into openings 74 on the ratchet handle. The release handle has a depending protrusion 78 that has an opening 80 through which a prong 82 on ratchet handle 64 is inserted. The release handle has two drive pawls 84 that may engage with the spool ratchet gears 54 when the assembly is put together as will be further described below. The bias spring 66 is disposed between depending protrusion 78 and the ratchet handle on prong 82 such that it biases the release handle and drive pawls in the direction of engagement with the spool ratchet gears 54.

The entire assembly may be made of metal or plastic or combinations of metal and plastic as will be appreciated by those of ordinary skill. In one embodiment, spool 22 and ratchet wheels 24 are made of metal and locking bar 46 is made of metal. In another embodiment, the locking bar is metal, but the ratchet wheels are made of hard plastic. When this mixed material embodiment is employed, the plastic must be a hard plastic to prevent excessive wear and tear caused by the metal locking bar and drive pawls. In this embodiment the plastic is glass filled.

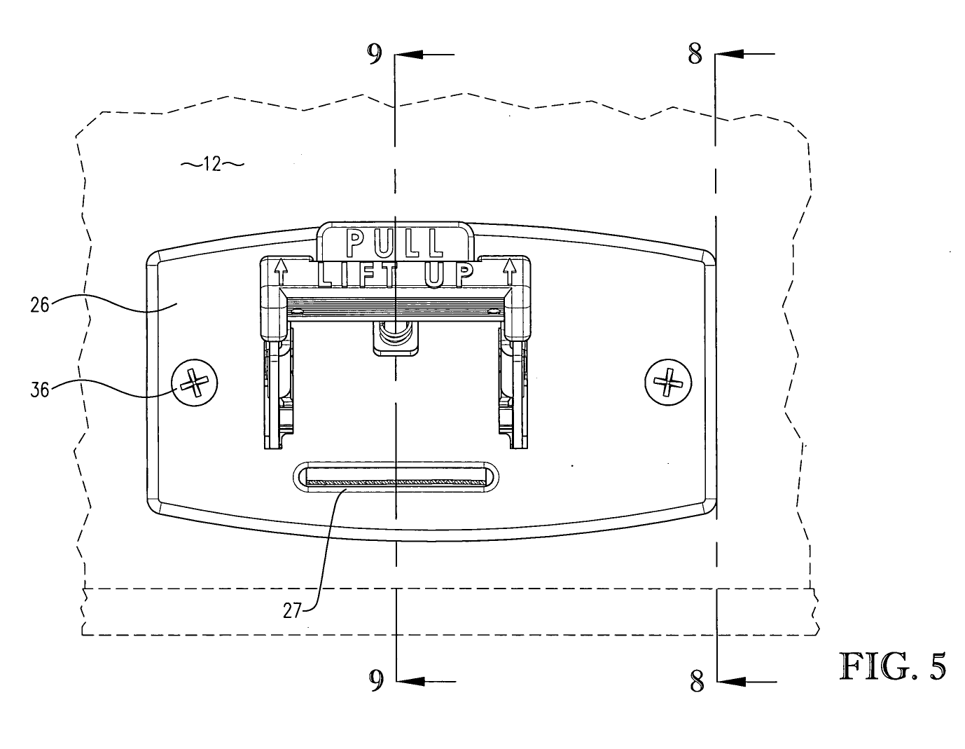

FIG. 5 shows a front view of spool assembly 16 mounted to a side wall 12. The entire assembly is mounted to side wall 12 by two screws 36 that extend through front panel 26 of the spool assembly through the side wall 12 of the boat. The assembly is mounted such that panel 26 and handle sub-assembly 28 are in front of wall 12 and spool 22 is behind wall 12. Elongated opening 27 in front panel 26 allows for passage of web 18. Handle 30 is of a size larger than opening 27 in at least one dimension to prevent web 18 and handle 30 from being retracted entirely behind front panel 26.

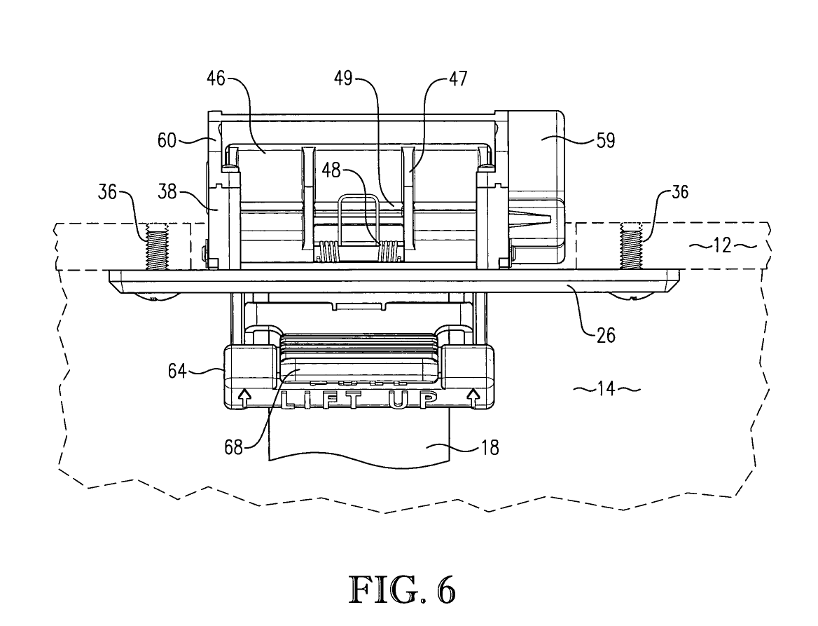

FIG. 6 shows a top view of the spool and handle assemblies mounted to the side wall of a boat. In this view, locking bar torsion spring 48 can be seen engaging a cross piece 49 that is orthogonal to cross members 47. Cross piece 49 is part of locking bar 46 and is the piece that torsion spring 48 biases to move locking bar 46 into engagement with ratchet gear teeth 54 as will be further described below.

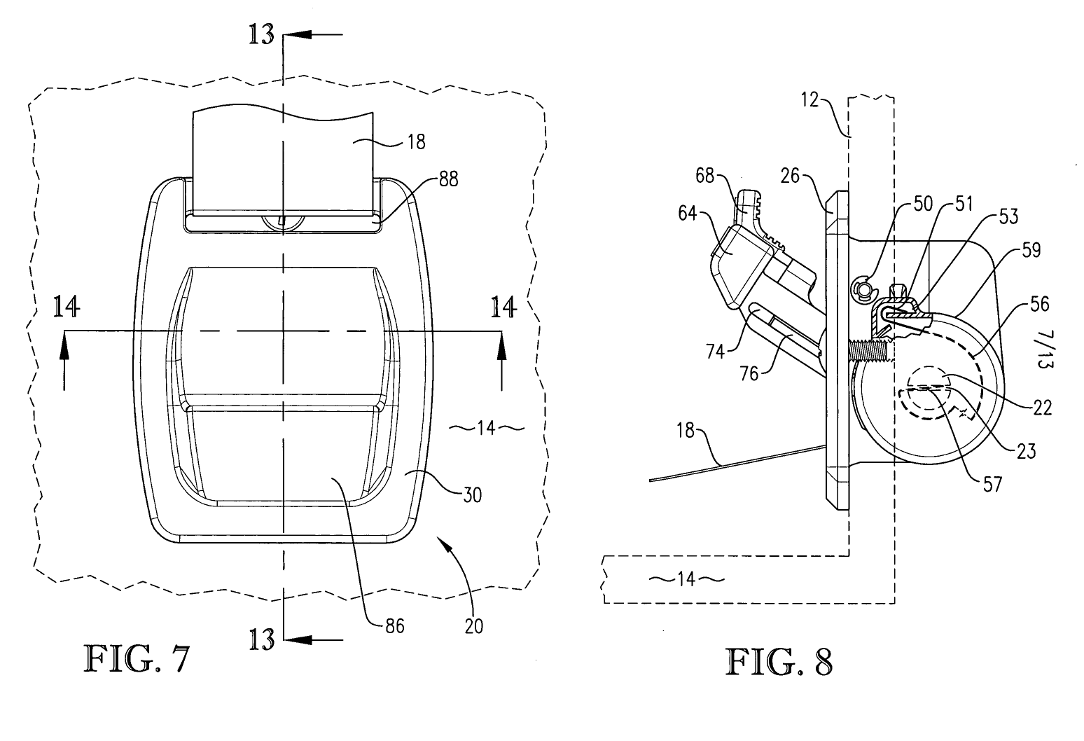

FIG. 7 shows a top view of the web handle assembly 20 mounted on bottom wall 14. Web handle assembly 20 includes handle 30 having a depression 86. Depression 86 is provided to allow for the insertion of the users fingers to grip handle 30 and extend the handle and web 18 away from wall 12. Handle 30 has an opening 88 on one end of the handle. Web 18 is attached to handle 30 through opening 88.

FIG. 8 shows a side view of the spool and handle assemblies taken at line 8 from FIG. 5. Flat torsion spring 56 can be seen in dashed line including spring lead 57 and a spring anchor 59. As best seen in this view, spring lead 57 is mounted to spool 22 (also shown in dash line) in opening 23. Spring anchor 51 is placed within an anchor receiving opening 53 that is formed within torsion spring housing 59. Opening 53 is formed such that spring anchor 51 will not come out of the opening when housing 59 is mounted over the spring.

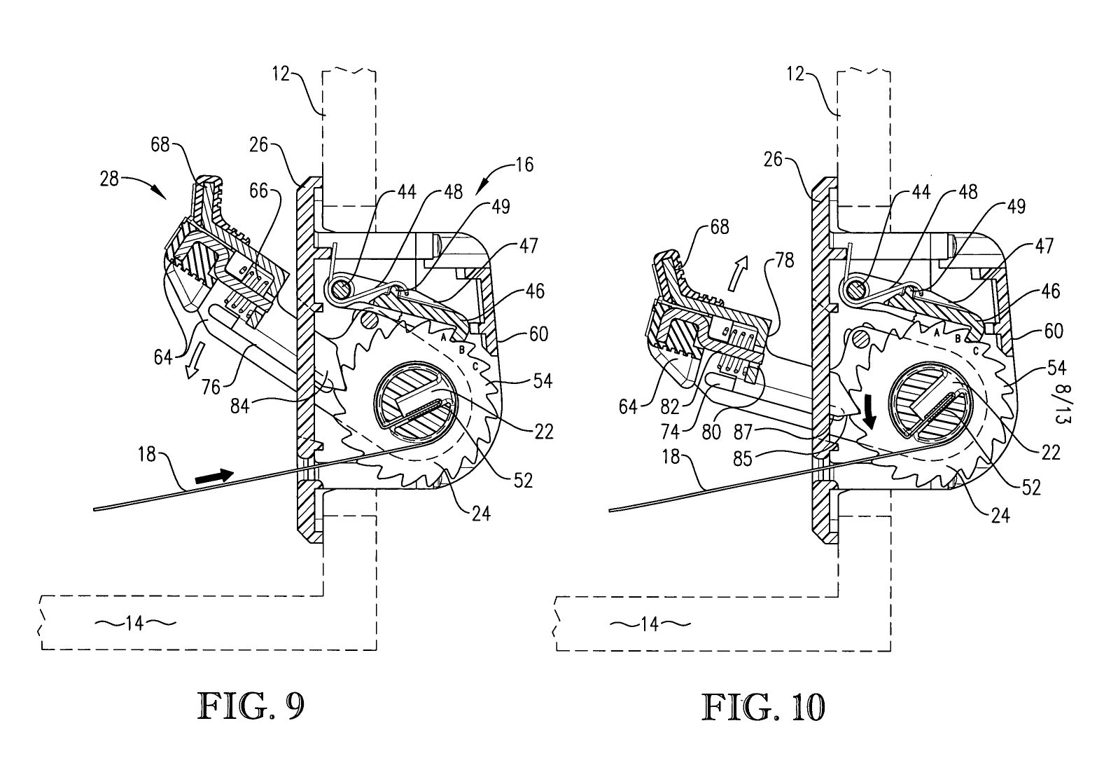

FIG. 9 shows a cross sectional side view of spool assembly 16 with ratchet handle sub-assembly 28 taken at line 9 from FIG. 5. In FIG. 9 the assembly is shown mounted to the side wall of the boat as with FIG. 8. Web 18 is shown attached to the spool at space 52. The web is wrapped around the spool. Locking bar 46 is shown engaged with the spool ratchet teeth 54 with several individual teeth labeled A, B, and C. Locking bar 46 is urged into engagement with the ratchet gear tooth A, in this figure, by the locking bar torsion spring 48 engaging with cross piece 49. In this teeth engaged position, the locking bar prevents the spool from rotating clockwise as depicted in FIG. 9 and thus prevents payout or extension of the web. The drive pawls 84 also engage ratchet gear teeth 54 in a similar manner as the locking bar. When ratchet handle 64 is moved in the direction of the arrow, the drive pawls cause the spool to rotate in the direction of retraction and thereby cause retraction of the web. When this counter-clockwise rotation occurs, locking bar 46 slides over the tops of teeth 54 and allows rotation of the spool in the direction of retraction.

Drive pawls 84 optionally have a safety slip feature to prevent over tightening the web to help prevent damage to the conveyance or rod holder by eliminating the chance of mounting screws pulling out. The drive pawls 84 have a lower front face 85 (FIG. 10) which is formed with an angle from the drive pawl bottom surface 87. The angle is measured between drive pawl front face 85 and a tangent line extended from drive pawl bottom surface 87 towards the spool. This angle allows the drive pawl to slip over ratchet teeth 54 without further turning spool 22 and tightening web 18 when 5-10 pounds of force are applied to web 18 in the direction of web extension. Typically this force is created by the fishing rods being held by web 18 and the handle stop 32 engaging handle 30 (described below). In one embodiment, the angle between face 85 and bottom surface 87 can be between 5°-10°. Most preferably the angle is 7.5°.

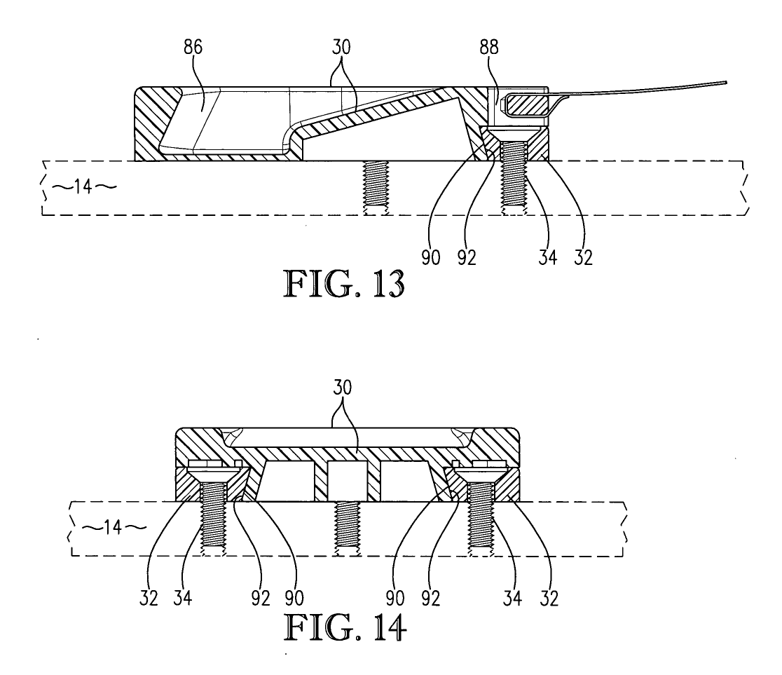

FIGS. 13 and 14 show a cross section of the web handle assembly 20 taken at lines 13 an 14 respectively from FIG. 7. The assembly includes web handle 30 and the web handle stop 32. Stop 32 is mounted typically to the bottom wall 14 of the conveyance using screws 34. There is a beveled inner wall 90 on stop 32 that engages with a counter-beveled wall 92 on handle 30. When handle 30 is slid into handle stop 32 the opposingly beveled walls 90 and 92 engage with each other. The two beveled walls 90, 92 mesh together and handle 30 will be stopped from moving in the direction of retraction of the web. The beveled walls 90, 92 are best seen in FIGS. 2 and 3.

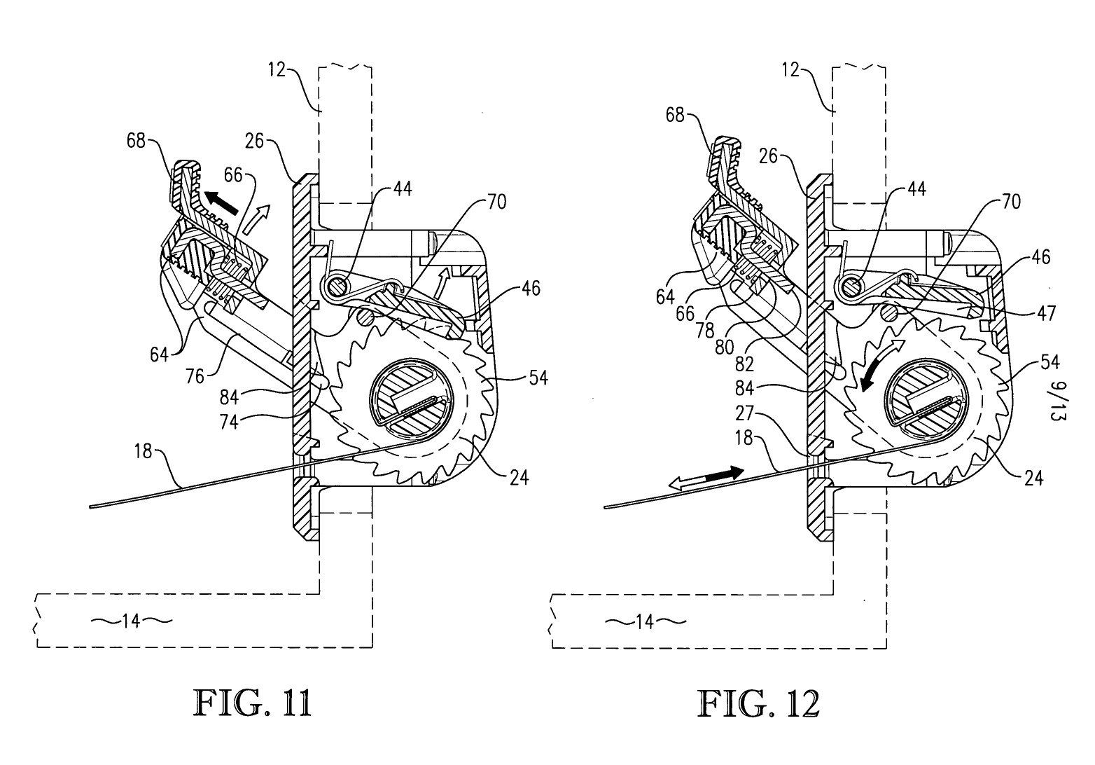

Reference is now generally made to FIGS. 9-12. In operation the spool assembly is mounted on sidewall 12 near the surface of bottom wall 14 (see FIG. 1). Handle stop 32 is mounted to bottom wall 14 of the conveyance with a gap between side wall 12 and stop 32 suitable to allow for the placement of multiple fishing rods to be held down by the fishing rod holder as may be desired by the user up to the length the web can be extended from wall 12. To extend web 18, the user moves ratchet handle 64 in the direction of the white arrow depicted on FIG. 11. Simultaneously, the user pulls on release handle 68 in the direction of the black arrow (FIG. 11) so that drive pawls 84 are disengaged from ratchet gear teeth 54. Ratchet handle 64 is rotated further upwards until ratchet handle rod 70 comes into engagement with locking bar cross members 47 as depicted in FIG. 12. The locking bar 46 has been pivoted upwards along with cross members 47 around the pivot point created by locking bar rod 44 so that locking bar 46 is no longer in engagement with ratchet gear teeth 54. In this position, spool 22 is free to rotate in either direction and the user can pull web 18 away from upright wall 12 by gripping handle 30 and pulling on it (see FIG. 1). The handle and web are extended over the fishing rods to be held and then the handle is fitted to the handle stop. When the ratchet handle and release handle are in the release position depicted in FIG. 12, the spool is urged to rotate in the retraction direction by the flat torsion spring 56 (not shown in FIG. 12). The torsion spring thereby tensions the web so that it slightly resists being pulled out by the user and slack will be taken up by the rotating spool when the handle is fitted to the handle stop. Because the web is retracted to its fully tightened position using the ratchet operation described below, the torsion spring is not necessary for retracting the web or holding the fishing rods in place. Thus, torsion spring 56 may be relatively weak. In one embodiment, torsion spring 56 is made of spring steel having 0.01″ thickness, 0.395″ width and a length of 40″. It is estimated that this spring exerts 50% of the force exerted by a spring required to hold the fishing rods in place without the help of a web locking device.

The user then releases the release handle and bias spring 66 urges the release handle towards the spool causing drive pawls 84 to re-engage with ratchet teeth 54 (see FIG. 9). Next the user urges ratchet handle 64 downwards toward bottom wall 14 as depicted in FIG. 9 causing spool 22 to rotate in the direction of retraction thereby tightening web 18. As ratchet handle 64 is lowered, locking bar rod 70 no longer forces the locking bar upwards and locking bar torsion spring 48 urges locking bar 46 downwards into engagement with ratchet teeth 54. To further tighten web 18, the user may repeatedly raise and lower ratchet handle 64 without pulling out release handle 68 (FIG. 10). Drive pawls 84 slide over the tops of ratchet teeth 54 and then bias spring 66 causes them to engage with ratchet gear teeth 54 in the familiar manner that allows tightening of web 18. As ratchet handle 64 is lowered again from the upright release position depicted in FIG. 12, spool 22 is rotated in the direction of retraction. As the web is tightened by the ratcheting action, locking bar 46 rides over the top of ratchet gear teeth 54, allowing for tightening of the web, but then preventing loosening of the web by its engagement with the faces of the ratchet gear teeth 54. This action continues until the web is securely holding the fishing rods to bottom wall 14. Because locking bar 46 prevents spool 22 from rotating in the direction of extension once this operation is complete, the web is substantially held in place and the fishing rods are thereby substantially held securely to bottom wall 14.

This locking bar arrangement is especially advantageous when installed on pleasure craft, such as bass fishing boats and the like, because as the craft moves through the water and encounters waves the vibration and bouncing of the boat deck or bottom wall 14 does not cause the rods to jump and/or bounce on the boat deck. By securely fastening the rods to the boat deck, damage to the rods is prevented and a potential safety hazard of the rods getting loose or distracting the boat operator at a key time is prevented.

In another embodiment, rather than providing a ratchet the spool is free to rotate at all times. However, the spool is still provided with gear teeth 54, a locking bar 46, and release handle 28 as with the FIG. 9 embodiment. No drive pawl is necessary because the torsion spring retracts the web. When the handle is lowered, the locking bar engages with the gear teeth and prevents the web from extending.

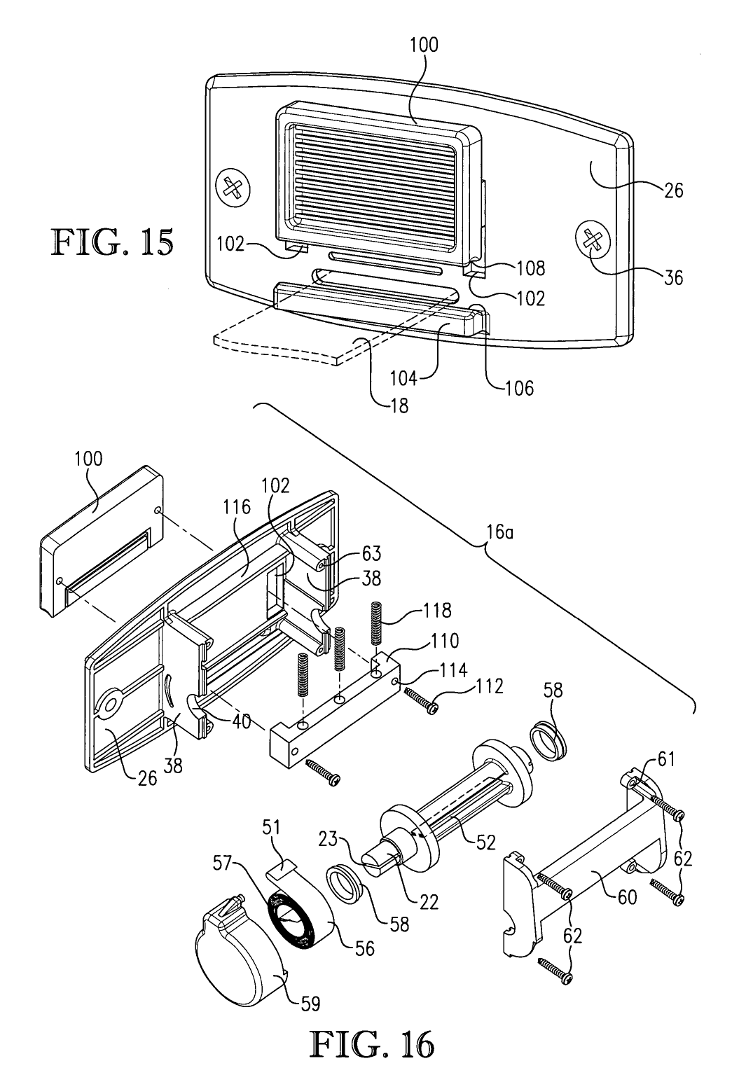

In yet another embodiment, a pinching element can perform the web locking function. Turning to FIG. 15, a front perspective view of a fishing rod holder employing a pinching element to perform the web locking function is depicted. As with the prior embodiments, any appropriate means may be employed to secure the web to the bottom wall (e.g., the handle 30 and handle stop 32 of FIG. 3) and over the fishing rods when they are placed on the bottom wall of the boat. In discussing this embodiment, parts common to the prior embodiments will be given the same numerical designations for the sake of clarity and only those features that differ from the prior embodiments will be addressed. The FIG. 15 embodiment differs from the prior embodiments primarily in its web locking feature. This embodiment employs a web pinching mechanism to lock down the web after it has been extended. The rod holder has a slidable web lock plate 100 that is slidably mounted to face plate 26 through two openings 102. Protruding from the front of plate 26 is a web pinch bar 104. Bar 104 has a top surface with an engaging protrusion 106. Plate 100 has a groove 108 on its underside that engages with protrusion 106 when the plate is slid all the way down. The protrusion and groove fit together and pinch web 18 such that it is locked into position after web 18 has been extended. The pinch element creates sufficient friction to prevent the web from moving in either direction when ordinary forces from movement of the conveyance are applied to the web.

FIG. 16 is an exploded view of the FIG. 15 embodiment of the rod holder. FIG. 16 depicts spool assembly 16a and those elements that differ from spool assembly 16 depicted in FIG. 4 will be described. The spool assembly 16a does not utilize a ratchet and gear teeth on spool 22 to retract web 18. Spool assembly 16a relies solely on flat torsion spring 56 for retraction of the web. Thus, flat torsion spring 56 differs from the FIG. 4 embodiment because the torsion spring is the only means for causing retraction of the web and the flat torsion spring must be of a higher strength to achieve web retraction as compared to the FIG. 4 embodiment. Additionally, there is no locking bar to arrest the web movement. Rather, a web pinch element is employed. Web lock plate 100 is slideably mounted to panel 26 through openings 102 in the panel by attaching a cross bar 110 to the backside of plate 100 using screws 112 attached through openings 114 as shown. In this embodiment, front panel 26 includes an upper cross bar 116 fixedly attached to the back side of the front panel. Springs 118 are interposed between the bottom of upper cross bar 116 and the top of movable cross bar 110. The springs 118 will be of sufficient strength to create the web lock friction at the interface of groove 108 and protrusion 106 to prevent the web from moving under ordinary conditions. However, the springs 118 must also be sized such that the downward force they exert can be relatively easily overcome by the user so as not to inhibit ease of use of the rod holder when the user desires to extend the web 18 over the fishing rods.

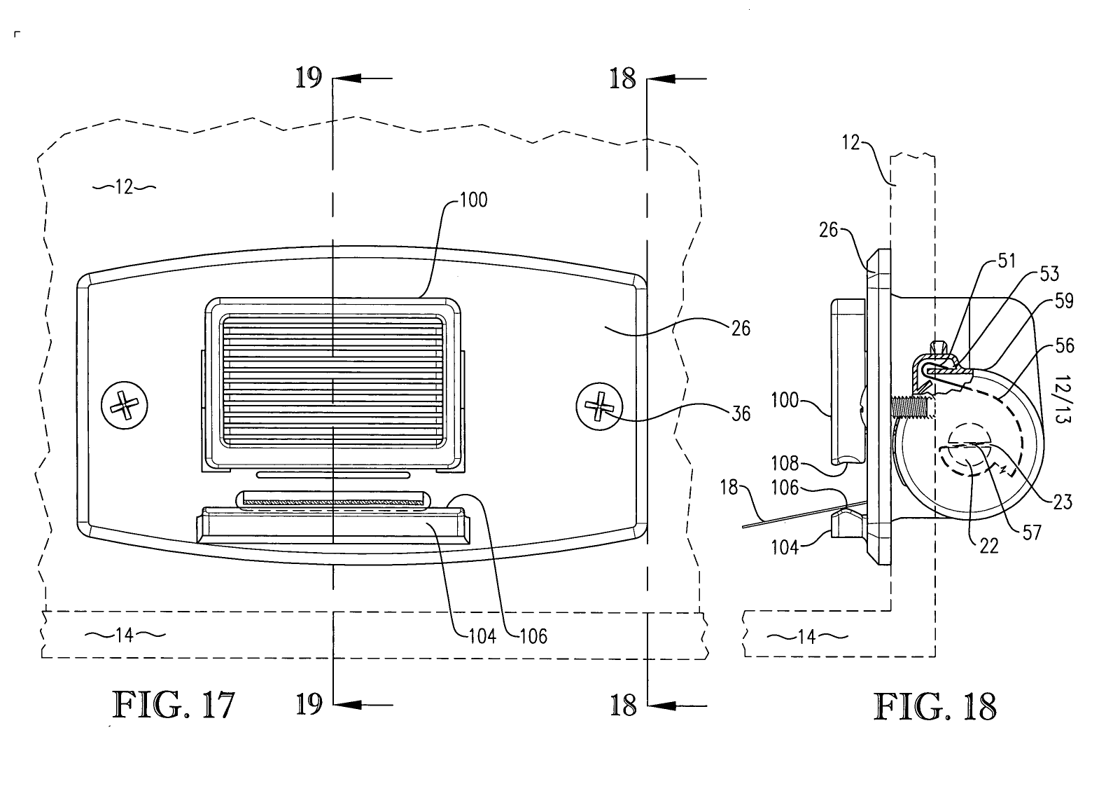

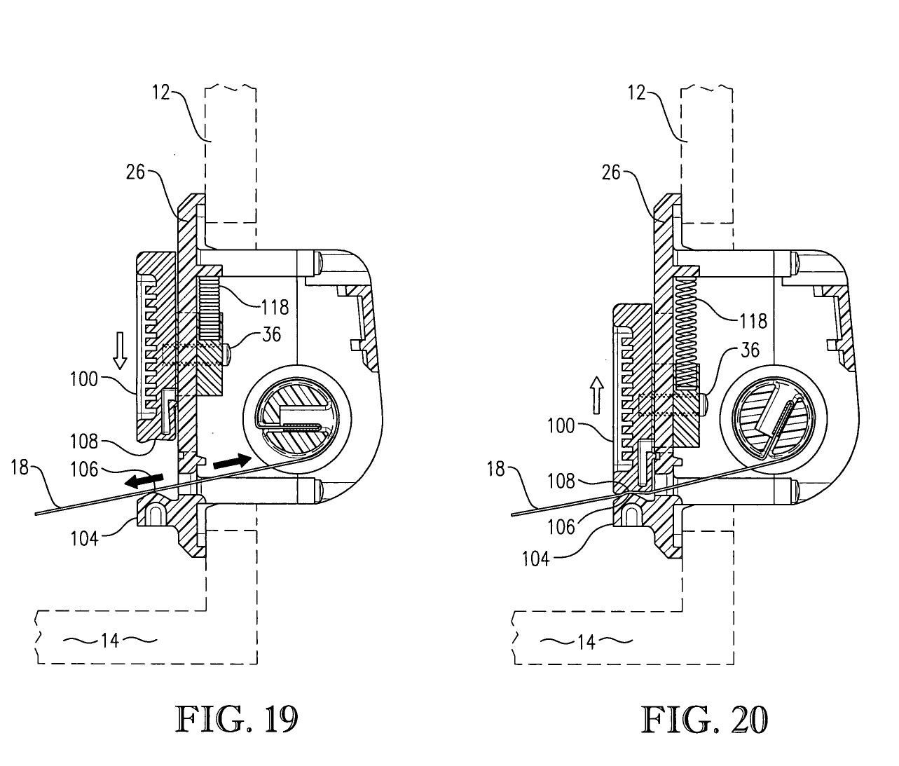

Reference is had to FIGS. 19 and 20 to describe operation of this embodiment. FIG. 19 shows a cross sectional side view of the fishing rod holder taken at line 19 from FIG. 17. As depicted in this figure, the holder is mounted to a side wall 12 by screws 36. The fishing rod holder is in the open or unlocked position, i.e., the slideable web lock plate 100 has been pulled upward against the bias of springs 118 so that web 18 is freely moveable in either direction as depicted by the darkened arrows. Springs 118 bias the web lock plate downwards in the direction of the unshaded arrow and the flat torsion spring urges the spool to turn in the direction of retraction of the web. The user manually pulls on the web to overcome the flat torsion spring bias and pull the web out over the fishing rods and attach it to the bottom wall by any appropriate means. Flat torsion spring 56 urges spool 22 in the direction of retraction, ensuring web 18 will be held tight against the tops of the fishing rods. The user may then release the web lock plate 100 and bias springs 118 will cause it to slide into indirect engagement with protrusion 106. FIG. 20 shows the same cross sectional view as FIG. 19, except that slideable plate 100 has been released and is now in the locked position. In this position, the groove 108 of the web lock plate 100 indirectly engages with protrusion 106 (with the web in between them), firmly clamping web 18 into a locked position. In this position, web 18 is locked such that the ordinary forces encountered by the conveyance while moving will not overcome the friction caused by the engagement between groove 108 and protrusion 106 and the fishing rods will be firmly held in place.

The section headings used herein are for organizational purposes only and are not to be construed as limiting the subject matter described in any way. All literature and similar materials cited in this application, including but not limited to, patents, patent applications, articles, books, treatises, and internet web pages, regardless of the format such literature and similar materials are expressly incorporated by reference in their entirety for any purpose.

While the present teachings are described in conjunction with various embodiments, it is not intended that the present teachings be limited to such embodiments. On the contrary, the present teachings encompass various alternatives, modifications, and equivalents as will be appreciated by those of skill in the art.

We claim:

1. A holder for a fishing rod comprising:
a panel;
a spool mounted to the panel having a web mounted thereto, said web extendable in a first direction outwardly from said spool and retractable in a second direction inwardly towards said spool;
a web lock operably connected to said holder, said lock inhibiting said web from extending in said first direction;
a handle attached to said web for pulling said web in said first direction.

2. The holder of claim 1 wherein said spool has gear teeth and said web lock comprises a locking bar operable to engage said teeth to prevent said spool from rotating and thereby inhibit said web from extending in said first direction.

3. The holder of claim 2 wherein said holder further comprises a ratchet handle having a drive pawl operably connected to engage said gear teeth to cause said spool to rotate and retract said web in said second direction.

4. The holder of claim 3 wherein said drive pawl comprises at least one gear teeth engaging face, said face configured so that the drive pawl will slip out of engagement with said gear teeth when said ratchet handle is moved to retract said web and there is a predetermined force applied to the web in the first direction.

5. The holder of claim 4 wherein said drive pawl comprises a bottom surface and said gear teeth engaging face is formed at an angle from said bottom surface within the range of about 5°-10°.

6. The holder of claim 1 wherein said web lock directly contacts with said web to inhibit said web from extending in said first direction.

7. The holder of claim 6, said web lock comprising a pinch element.

8. The holder of claim 7, said pinch element comprising a front plate mounted on said panel and moveable to contact said web thereby substantially holding said web in place.

9. A fishing rod holder comprising:
a panel;
a spool mounted to the panel having a web mounted thereto, said web extendable in a first direction outwardly from said spool and retractable in a second direction inwardly towards said spool;
web locking means for substantially preventing said web from extending in said first direction;
a handle for pulling said web in said first direction;
means for retracting said web in said second direction; and
handle stop means for holding said handle in a spaced apart relationship from said panel.

10. The holder of claim 9 wherein said spool has gear teeth and said web locking means comprises a locking bar operable to engage said teeth to prevent said spool from rotating and thereby inhibit said web from extending in said first direction.

11. The holder of claim 10 wherein said holder further comprises a ratchet handle having a drive pawl operably connected to engage said gear teeth to cause said spool to rotate and retract said web in said second direction.

12. The holder of claim 11 wherein said drive pawl comprises at least one gear teeth engaging face, said face configured so that the drive pawl will slip out of engagement with said gear teeth when said ratchet handle is moved to retract said web and there is a predetermined force applied to the web in the first direction.

13. The holder of claim 12 wherein said drive pawl comprises a bottom surface and said gear teeth engaging face is formed at an angle from said bottom surface within the range of about 5°-10°.

14. The holder of claim 9 wherein said web locking means directly contacts with said web to inhibit said web from extending in said first direction.

15. The holder of claim 14, said web locking means comprising a pinch element.

16. The holder of claim 15, said pinch element comprising a front plate mounted on said panel and moveable to contact said web thereby substantially holding said web in place.

17. A method of retaining fishing rods against the wall of a conveyance comprising:
providing a spool rotateably mounted to a first wall, said spool having a retractable web wrapped thereon, said web extendable in a first direction;
providing a handle attached to said web;
providing a handle stop spaced apart from said spool;
providing a web lock;
extending said web in said first direction over at least one fishing rod and engaging said handle with said handle stop;
retracting said web to tighten it over at least one rod; and
engaging said web lock.

18. The method of claim 17 wherein said web lock comprises a locking bar, said spool having gear teeth, said locking bar being capable of engaging said gear teeth to lock said spool and prevent it from rotating in said first direction.

19. The method of claim 17 wherein said web lock comprises a pinch element.
